(19) United States
(12) Patent Application Publication
(10) Pub. No.: US 2007/0154171 A1
(43) Pub. Date: Jul. 5, 2007

(54) Navigating recorded video using closed captioning

(76) Inventors: Albert Fitzgerald Elcock, Havertown, PA (US); John Kamienicki, Lafayette Hill, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/326,217

(22) Filed: Jan. 4, 2006

(51) Int. Cl. H04N 5/91

(52) U.S. Cl. 386/83

(57) ABSTRACT

Video navigation is provided where a video stream encoded with captioning is received. A user-searchable captioning index comprising the captioning and synchronization data indicative of synchronization between the video stream and the captioning is generated. In illustrative examples, the synchronization is time-based, video-frame-based, or marker-based.

### CROSS REFERENCE TO RELATED APPLICATION

This application is related to U.S. patent application Ser. No. ______ [Motorola Docket No. BCS03870B] entitled “Navigating Recorded Video using Captioning, Dialogue and Sound Effects” filed concurrently herewith.

### COPYRIGHT AUTHORIZATION

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### TECHNICAL FIELD

This disclosure is related generally to browsing and navigating video, and more particularly to navigating recorded video using closed captioning.

### BACKGROUND OF THE INVENTION

The amount of video content available to consumers is very large due in part to the use of digital storage and distribution. Whether purchased or rented on DVD (digital versatile disc) or through subscription to video content delivery services such as cable or satellite, consumers often are looking to browse through, or navigate to specific locations in video content. For example, a user watching a movie from a DVD (or from a recording made on a digital video recorder, or DVR) may often wish to skip a specific scene. Fortunately, video in digital format gives users an ability to jump right to the scene of interest. This is a big advantage over traditional media such as VHS videotape which typically can only be navigated in a sequential (i.e., linear) manner using the fast-forward or rewinds controls.

Existing navigation schemes generally require indexing information to be generated that is related to the digital video. A user is presented with the index—typically through an interactive interface—to thereby navigate to a desired scene (which is sometimes called a “chapter” in a DVD) or other point in the video program.

With DVDs, the scene or chapter index is authored as part of the DVD production process. This involves designing the overall navigational structure; preparing the multimedia assets (i.e., video, audio, images); designing the graphical look; laying out the assets into tracks, streams, and chapters; designing interactive menus; linking the elements into the navigational structure; and building the final production to write to a DVD. The DVD player uses the index information to determine where the desired scene begins in the video program.

Users are generally provided with a visual display placed by the DVD player onto the television (such as a still photo of a representative video image in the chapter of interest, along perhaps with a chapter title in text) to aide the navigation process. Users can skip ahead or back to preset placeholders in the DVD using an interface such as the DVD player remote control.

With DVRs, the navigation capabilities are typically enabled during the playback process of recorded video. Here, users use the DVR remote control to instruct the DVR to skip ahead or go back in the program using a set time interval. Some DVR systems can locate scene changes in the digital video in real time (i.e., without a scene start and end information determined ahead of time as with the DVD authoring process) to enable a user to jump through scenes in a program recorded on a DVR much like a DVD. However, no chapter index with visual cues is typically provided by the DVR.

While current digital video navigation arrangements are satisfactory in many applications, additional features and capabilities are needed to enable users to locate scenes of interest more precisely and in less time. There is often no easy way to locate these scenes, aside from fast forwarding or rewinding (i.e., fast backwards) through long sequences of video until the material of interest is found. The chapter indexing in DVDs lets the user jump to specific areas more quickly, but this is not usually sufficiently granular to meet all user needs. Additionally, if the user is uncertain about the chapter in which the scene resides, the DVD chapter index provides no additional benefit.

### BRIEF DESCRIPTION OF THE DRAWING

FIG. 1 is a flow chart of an illustrative method showing closed captioning processing, closed captioning storage, and closed captioning retrieval;

FIG. 2 is a block diagram of an illustrative arrangement showing a video navigation apparatus using closed captioning;

FIG. 3 is an illustrative example of a graphical navigation menu using closed captioning;

FIG. 4 is an illustrative example of a graphical navigation menu using closed captioning in which nearest matches to user queries are displayed;

FIG. 5 is an illustrative example of a graphical navigation menu in which pre-selected dialogue is displayed as a navigation aide;

FIG. 6 is a block diagram of illustrative arrangement showing video navigation using closed captioning with local and remotely-located equipment;

FIG. 7 is a block diagram showing details of the local equipment for video navigation using closed captioning; and

FIG. 8 is a pictorial representation of a television screen shot showing a video image and a graphical navigation menu that is superimposed over the video image.

### DETAILED DESCRIPTION

Closed captioning has historically been a way for deaf and hard of hearing/hearing-impaired people to read a transcript of the audio portion of a video program, film, movie or other presentation. Others benefiting from closed captioning include people learning English as an additional language and people first learning how to read. Many studies have shown that using captioned video presentations enhances retention and comprehension levels in language and literacy education.

As the video plays, words and sound effects are expressed as text that can be turned on and off at the user's discretion so long as they have a caption decoder. In the United States, since the passage of the Television Decoder Circuitry Act of 1990 (the Act), manufacturers of most television receivers have been required to include closed captioning decoding capability. Television sets with screens 13 inches and larger, digital television receivers, and equipment such as set-top-boxes (STBs) for satellite and cable television services are covered by the Act.

The term “closed” in closed captioning means that not all viewers see the captions—only those who decode and activate them. This is distinguished from open captions, where the captions are permanently burned into the video and are visible to all viewers. As used in the remainder of the description that follows, the term “captions” refers to closed captions unless specifically stated otherwise.

Captions are further distinguished from “subtitles.” In the U.S. and Canada, subtitles assume the viewer can hear but cannot understand the language, so they only translate dialogue and some onscreen text. Captions, by contrast, aim to describe all significant audio content, as well as “non-speech information,” such as the identity of speakers and their manner of speaking. The distinction between subtitles and captions is not always made in the United Kingdom and Australia where the term “subtitles” is a general term and may often refer to captioning using Teletext.

To further clarify between subtitles and captioning, subtitling on a DVD is accomplished using a feature known as subpictures while captions are encoded into the DVD's MPEG-2 (Moving Picture Experts Group) digital video format. Each individual subtitle is rendered into a bitmap file and compressed. Scheduling information for the subtitles is written to the DVD along with the bitmaps for each subtitle. As the DVD is playing each subpicture bitmap is called up at the appropriate time and displayed over the top of the video picture.

For live programs in countries that use the analog NTSC (National Television System Committee) television system, like the U.S. and Canada, spoken words comprising the television program's soundtrack are transcribed by a reporter (i.e., like a stenographer/court reporter in a courtroom using stenotype or stenomask equipment). Alternatively, in some cases the transcript is available beforehand and captions are simply displayed during the program. For prerecorded programs (such as recorded video programs on television, videotapes and DVDs), audio is transcribed and captions are prepared, positioned, and timed in advance.

For all types of NTSC programming, captions are encoded into Line 21 of the vertical blanking interval (VBI)—a part of the TV picture that sits just above the visible portion and is usually unseen. “Encoded,” as used in the analog case here (and in the case of digital video below) means that the captions are inserted directly into the video stream itself and are hidden from view until extracted by an appropriate decoder.

Closed caption information is added to Line 21 of the VBI in either or both the odd and even fields of the NTSC television signal. Particularly with the availability of Field 2, the data delivery capacity (or “data bandwidth”) far exceeds the requirements of simple program related captioning in a single language. Therefore, the closed captioning system allows for additional “channels” of program related information to be included in the Line 21 data stream. In addition, multiple channels of non-program related information are possible.

The decoded captions are presented to the viewer in a variety of ways. In addition to various character formats such as upper/lower case, italic, and underline, the characters may “Pop-On” the screen, appear to “Paint-On” from left to right, or continuously “Roll-Up” from the bottom of the screen. Captions may appear in different colors as well. The way in which captions are presented, as well their channel assignment, is determined by a set of overhead control codes which are transmitted along with the alphanumeric characters which form the actual caption in the VBI.

Sometimes music or sound effects are also described using words or symbols within the caption. The Electronic Industries Alliance (EIA) defines the standard for NTSC captioning in EIA-608B. Virtually all television equipment including videocassette players and/or recorders (collectively, VCRs), DVD players, DVRs and STBs with NTSC output can output captions on line 21 of the VBI in accordance with EIA-608B.

For ATSC (Advanced Television Systems Committee) programming (i.e., digital- or high-definition television, DTV and HDTV, respectively, collectively referred to here as DTV), three data components are encoded in the video stream: two are backward compatible Line 21 captions, and the third is a set of up to 63 additional caption streams encoded in accordance with another standard—EIA-708B. DTV signals are compliant with the MPEG-2 video standard.

Closed captioning in DTV is based around a caption window (i.e., like a “window” familiar to a computer user. The caption window overlays the video and closed captioning text is arranged within it). DTV closed caption and related data is carried in three separate portions of the MPEG-2 data stream. They are the picture user data bits, the Program Mapping Table (PMT) and the Event Information Table (EIT). The caption text itself and window commands are carried in the MPEG-2 Transport Channel in the picture user data bits. A caption service directory (which shows which caption services are available) is carried in the PMT and optionally for cable, in the EIT. To ensure compatibility between analog and digital closed captioning (EIA-608B and EIA-708B, respectively), the MPEG-2 transport channel is designed to carry both formats.

The backwards compatible line 21 captions are important because some users want to receive DTV signals but display them on their NTSC television sets. Thus, DTV signals can deliver Line 21 caption data in an EIA-708B format. In other words, the data does not look like Line 21 data, but once recovered by the user's decoder, it can be converted to Line 21 caption data and inserted into Line 21 of the NTSC video signal that is sent to an analog television. Thus, line 21 captions transmitted via DTV in the EIA-708B format come out looking identical to the same captions transmitted via NTSC in the EIA-608B format. This data has all the same features and limitations of 608 data, including the speed at which it is delivered to the user's equipment.

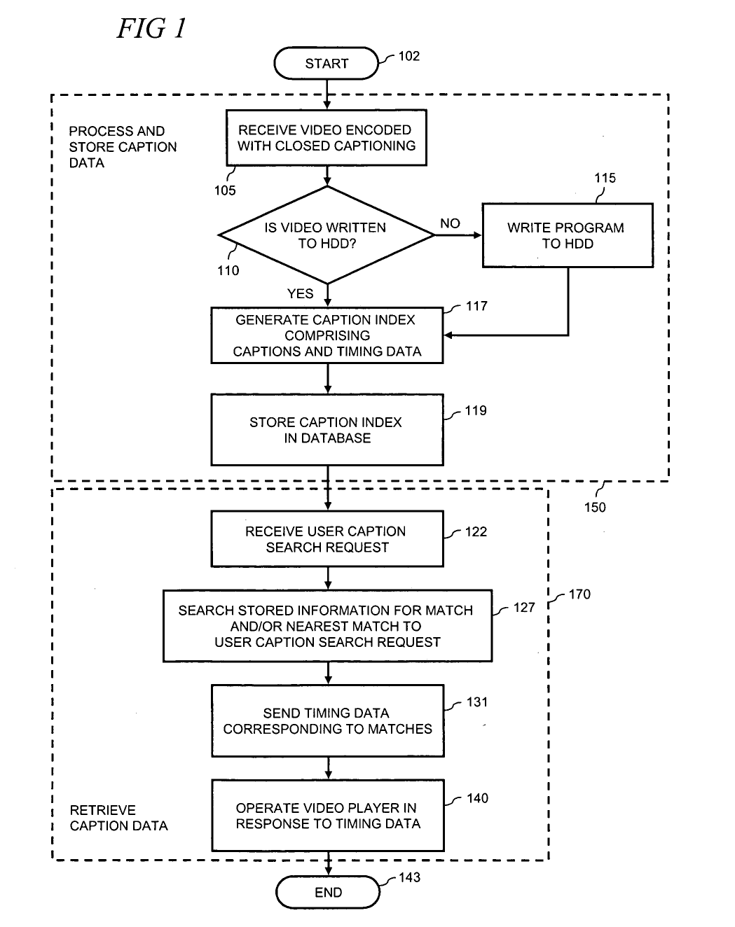

Turning now to FIG. 1, a flow chart of an illustrative method shows two related processes: caption processing and storage; and caption retrieval. The method starts at block 102. Blocks 105 through 119 illustrate caption processing and storage. Blocks 122 through 140 illustrate caption retrieval. The method ends at block 143.

The illustrative method shown in FIG. 1 is applicable to settings where video content delivery is provided and received over networks including cable, satellite, the Internet (and other Internet Protocol or “IP” based networks), wireless and over-the-air networks. Such video content includes, for example, movies and television programming that originates away from a user's location at a home or office. Both broadcast video services (including pay-per-view and conventional access) and individual, time-independent video services such as video-on-demand (VOD) may provide video content using network distribution.

In addition to network content delivery, the illustrative method shown in FIG. 1 is equally applicable to locally-provided video content as well. Video content typically comes from portable media such as DVD or videocassette that is played at a user's location. No network connectivity is required in such a case.

The captioning processing and storage process is indicated by reference numeral 150 in FIG. 1. At block 105, a video stream encoded with captioning is received. The video stream in this example is an analog NTSC-formatted movie video with encoded captioning in compliance with EIA-608B. However, in other applications, the video stream with captioning is encoded in an MPEG-2 format in compliance with EIA-708B, as with DVDs and in most VOD applications, for example, where digital video is provided to a user upon request through a distribution network such as satellite or cable television. Whether analog or digital video formats are used is dependent on a number of factors, but the present video navigation using closed captioning may be advantageously used with either format.

As an analog NTSC signal, the video stream includes captioning data in line 21 of the VBI. At decision block 110 in FIG. 1, a determination is made whether the incoming video stream is already written to a hard disk drive (HDD). If not, then the method continues to block 115 where the video stream is written to a HDD. Typically, the analog NTSC signal will be converted to MPEG-2 digital format for storage on the HDD and the EIA-608B-compliant captions will be up-converted to EIA-708B format.

In other applications, other video formats and HDD storage formats are used. For example, Microsoft Windows Media-based content, RealNetworks Real Media-based content, and Apple Quick Time-based content can all support captioning.

It is noted that the use of the HDD is typically used in most applications although not required in every application. The HDD generally allows the captioning index, as described below in detail, to be generated more quickly than creating the captioning index as the video stream is received. For example, a television movie with an on-air run time of two hours would require two hours to create the captioning index if an HDD is not utilized. That is, the captioning index generation rate is limited by the rate at which the video can be received. The same movie once written to HDD could be indexed “offline” at a substantially faster speed (i.e., on the order of just several minutes depending on the speed of the processor used to generate the captioning index). In this latter case, the time to generate the captioning index would not be limited by the intake rate of the video. In other applications of video navigating using closed captioning it may be desirable to reduce the time required to generate the captioning index by selectively decoding data included in the incoming video. For example, in digital applications captions are encoded in the picture user data bits associated with I (intracoded) frames in the MPEG GOP (group of pictures). Accordingly, captioning may be decoded without decoding other frames (i.e., non I-frame video frames).

At block 117, the method continues with the generation of a captioning index. The illustrative method described here recognizes that captions need to appear on screen as closely as possible to when the words being captioned are spoken. That is, specific words, phrases or dialog in the captioning text are synchronized on a one-to-one basis with specific visual events contained in the movie video. The captions are typically encoded into the VBI of video frames in the movie so that when decoded they appear on the screen time-synchronously with the images of the character speaking the lines.

Although the captioning is generally encoded in the video to be timed to match exactly when words are spoken, in some instances this can be difficult, particularly when captions are short, a burst of dialogue is very fast, or scenes in the video are changing quickly. The encoding timing must also take reading-rates of viewers and control code overhead into account. All of these factors may result in some offset between the caption and the corresponding video images. Typically, the captions may lag the video image or remain on the screen longer in such situations to best accommodate these common timing constraints.

In this illustrative method, the captioning index is generated by mapping each of the captions encoded in the video stream against a corresponding and unique data point in a synchronization database on a one-to-one basis. In this illustrative example, the synchronization is time-based whereby each particular caption encoded in the video stream is mapped to the unique time that each particular caption appears in the movie video.

For example, the movie video “Star Wars” is encoded with captions for dialogue between characters which include:

Line 1: “Hokey religions and ancient weapons are no match for a good blaster at your side, kid.”

Line 2: “You don't believe in the Force, do you?”

Line 3: “Kid, I've flown from one side of this galaxy to the other. I've seen a lot of strange stuff, but I've never seen anything to make me believe there's one all-powerful force controlling everything. There's no mystical energy field that controls my destiny.”

© 1977, 1997 & 2000 Lucasfilm Ltd.

Line 1 is spoken by the character approximately 60 minutes and 49 seconds (60:49) from the beginning of the movie video; Line 2 occurs at 60:54; and Line 3 occurs at 60:57.

Typically, in most applications, the caption index is generated sequentially from the beginning of the movie video to the end. Thus, the movie is scanned from the HDD and captioning data is read from the VBI. At the beginning of the scan, a time counter (e.g., a clock) is set to zero and incremented as the scan of the movie video progresses. As each caption is decoded from the movie video, a notation of the time counter reading is made into the synchronization database. The captioning index thus comprises an ordered list with data entries for each of the decoded captions from the movie video and the time-synchronous time counter reading.

While this illustrative method uses time-based synchronization between the incoming video stream and the synchronization data included in the captioning index, other techniques may be advantageously utilized depending upon the specific requirements of an application. For example, video-frame-based and marker-based techniques are also contemplated.

In the video-frame-based technique, an external counter is not used. Instead, synchronization is established by identifying video frames corresponding to the captioning by data contained the video stream itself. In particular, the vertical interval timecode (VITC) defined by the Society of Motion Pictures and Television Engineers (SMPTE) is recorded directly into the VBI of each video frame. The VITC is a binary coded decimal in hour:minute:second:frame identification to uniquely identify each frame of video. In this video-frame-based example, the captioning index comprises an ordered list with data entries for each of the decoded captions from the movie video and the video-frame-synchronous identification from the SMPTE timecode. Accordingly, in the video frame-based technique, the captioning index includes data entries for the decoded captions and synchronous VITC data.

Using the dialogue example above, with a 30 frames/second frame rate, each frame in the video is identified by a unique six digit number. The Line 1 caption which is spoken 3,649 seconds from the beginning of the movie includes a video-frame number of 109470 in the captioning index. Similarly, the Line 2 caption is associated with video-frame number 109620 and the Line 3 is associated with video-frame number 109710.

In the marker-based example, neither an external counter nor the internal timecode is used. Instead, as the video is scanned (upon receipt, or out of the HDD), a location marker is generated to mark the spot in the video (i.e., locate) where each caption occurs. A marker, in this illustrative example, comprises any metadata that points to a specific location in the video. For example, in a similar manner that chapter markers and bookmarks are authored in MPEG-encoded DVDs, the captioning index may include a location marker that is readable by video players.

Each location marker is unique (for example, each one having a different number or other identifying characteristic) to create the required one-to-one synchronization between the captions and the location markers. In this marker-based technique, the captioning index comprises an ordered list with data entries for each of the decoded captions from the movie video and the synchronous markers.

Returning to FIG. 1, the illustrative method (using time-based synchronization) continues at block 119. Here, the captioning index is stored, for example on an HDD.

The caption retrieval portion of the illustrative method is now presented and indicated by reference numeral 170 in FIG. 1. A query from a user is received at block 122. The query, in this example, is a search from a user which contains phrases, tag lines or keywords that the user anticipates are contained in the movie video. The ability to search captioning in the video may be useful for a variety of reasons. For example, navigating a video by dialogue or sound effects provides a novel and interesting alternative to existing chapter indexing or linear searching using fast forward or fast backward. In addition, users frequently watch video programs and movies over several viewing sessions. Dialogue may serve as a mental “bookmark” which helps a user recall a particular scene in the video. By searching the captioning for the dialogue of interest and locating the corresponding scene, the user may conveniently begin viewing where he or she left off.

As described in detail below, the user searching is facilitated with a user interface which includes a graphic navigation menu. At block 127 the captioning index is searched for captions which match the user query. Optionally, the searching may be configured to employ a search algorithm that enables search time to be reduced or to return captions that most nearly match the user's query in instances when an exact match cannot be located.

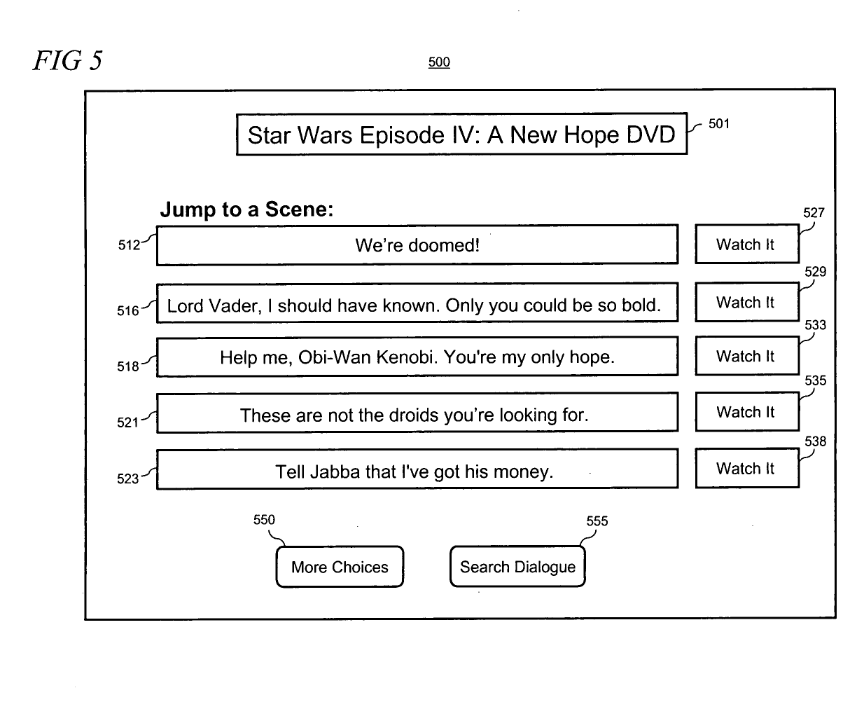

In a related optional method, the searching performed in block 127 in FIG. 1 is supplemented with a feature in which well known movie tag lines or phrases are pre-selected, for example, by a service provider. A selection of such pre-selected famous tag lines or phrases is then presented to the user. This optional method is described in more detail in the text accompanying FIG. 5 below.

In block 131, the synchronization data (which in this illustrative example is timing data) corresponding to matches with the user's query is sent. For example, if the user's query contained the phrase “no match for a good blaster” then timing data including 60:49 would be sent. Optionally, to accommodate any offset between the caption encoding and the occurrence of the video image containing the captioned dialogue (as noted above), the timing data includes an arbitrary time adjustment. For example, the timing data could be offset by an arbitrary interval, for example five seconds, to 60:44 to ensure that the scene from the movie video containing the phrase in the user's query is located and played in its entirety, or to provide context to the scene of interest. Note that the time adjustment may be implemented at block 131 in the illustrative method, or at block 140.

In block 140 of FIG. 1, a video player is operated in response to the timing data which was sent as noted in the description of block 131. Such a video player is selected from a variety of common devices including DVD players, DVRs, VCRs, STBs, personal computers with media players, and the like. The video player jumps to the location of the scene in the video program (in this case a movie video) having dialogue which matches the user's query. In this example, responsive to the timing data 60:49, the video player advances the movie video 60 minutes and 49 seconds from the beginning of the movie. The scene containing the dialogue matching the user's query is then played (and, as noted above, the optional time adjustment may be implemented by the video player to start playing the scene by some arbitrary time interval in advance of the occurrence of the dialog of interest). The illustrative method thereby advantageously enables video navigation by dialogue (or other information contained in the captioning data such as descriptive sound effects) instead of linear navigation or navigation using a preset chapter/scene index.

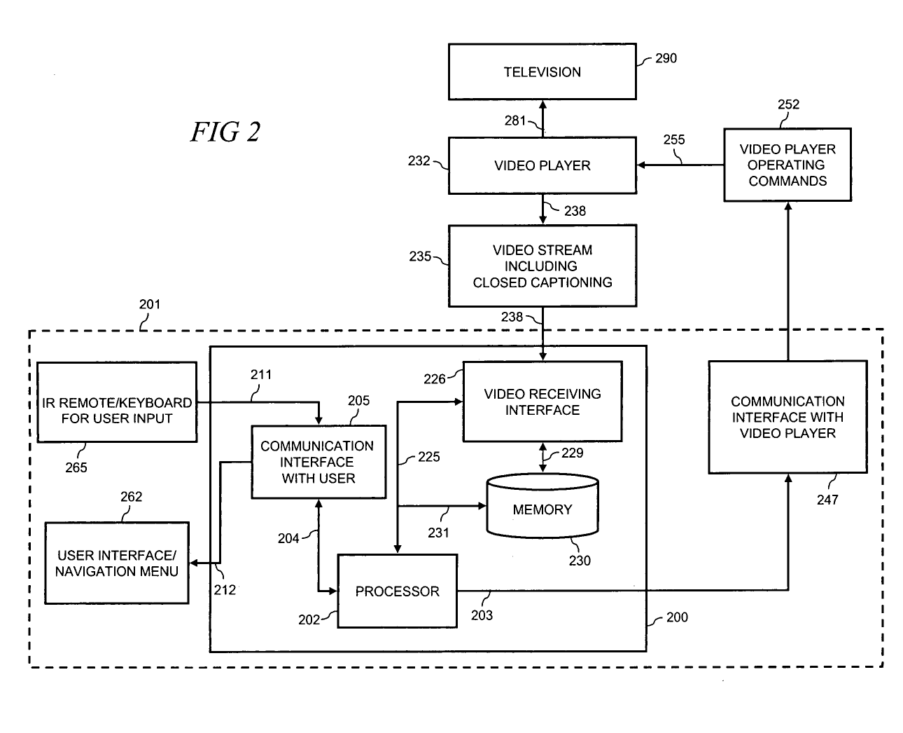

FIG. 2 is a block diagram of an illustrative arrangement showing a video navigation apparatus. A video navigation arrangement 201 includes a video navigation system 200. The video navigation system 200 comprises a processor 202, video receiving interface 226, memory 230, and user communication interface 205, as shown.

A user input device 265 comprising, for example, either an IR remote control, a keyboard, or a combination of IR remote control and keyboard is operatively coupled to video navigation system 200 on line 211 through the user communication interface 205. In alternative arrangements, user input device 265 is configured with voice recognition capabilities so that a user may provide input using voice commands.

User input device 265 enables a user to provide inputs to the video navigation system 200. A user interface 262, comprising a navigation menu, is coupled to video navigation system 200 through user communications interface 205 on line 212. The navigation menu is preferably a graphical interface in most applications whereby choices and prompts for user inputs are provided on a display or screen such as television 290 in FIG. 2. It is contemplated that user input device 265 and user interface 262 could also be incorporated into a single, unitary device in which the display device for the graphical navigation menu either replaces or supplements the television 290.

A video player 232 (which may be selected from devices including DVD players, DVRs, VCRs, or STBs) is coupled to television 290 on line 281 so that video (including pictures and sound) playing on video player 232 is shown on television 290. Video player 232 is coupled using line 238 to video receiving interface 226 in video navigation system 200 so that a video stream 235 which is encoded with captioning is received by video receiving interface 226. The video stream 235 is optionally stored in memory 230 as described above in the text accompanying FIG. 1. Memory 230 is arranged in this illustrative example as a HDD and coupled to video receiving interface 226 on line 229, as shown.

Processor 202 is operatively coupled to video receiving interface on line 225. Processor 202 will also be optionally coupled to memory 230 on line 231 in applications where memory 230 is used. Processor 202 creates a caption index in accordance with the illustrative method shown in FIG. 1 and described in the accompanying text. Processor 202 receives user search queries and requests through the user communication interface 205 over line 204 as shown in FIG. 2. Processor 202 is also arranged to supply display information over user communications interface 205 to user interface 262 to thereby enable a graphical navigation menu to a user.

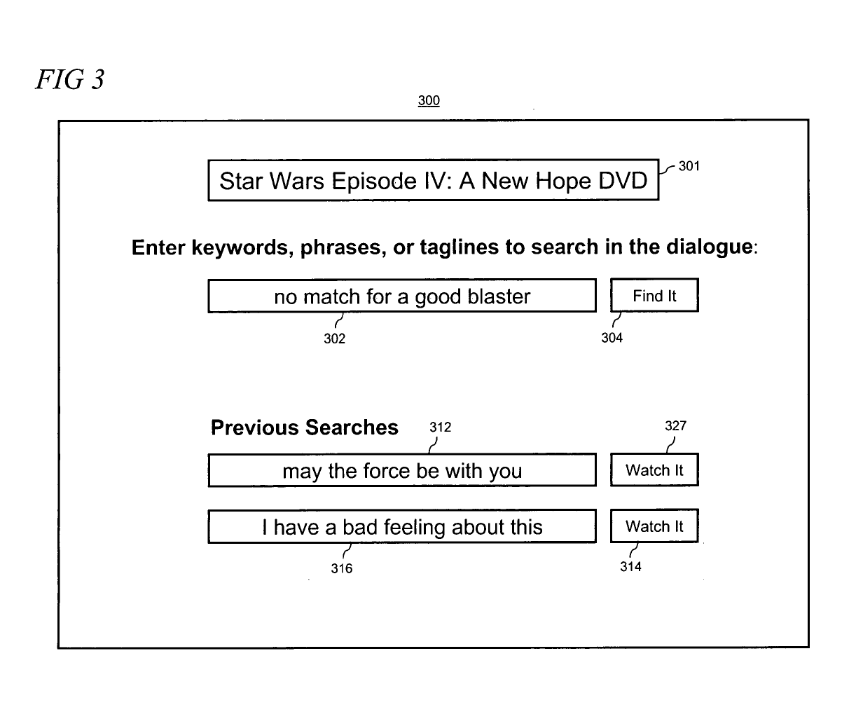

An example of such a graphical navigation menu is shown in FIG. 3. In this example, the movie video source is a DVD as indicated by the title field 301. A user input field 302 is arranged to accept alphanumeric input from the user which forms the user query. Button 304 labeled “Find it” is arranged to initiate the search of the captioning index once the query is entered in input field 302. As shown in FIG. 3, other fields 312 and 316 are populated with previous queries from the user. Such previous user searches would have already initiated searches of the captioning index to thereby locate the scene in the video movie containing the dialogue contained in the user query. Thus, buttons 327 and 314 are labeled “Watch it” and are arranged to initiate an operation of the video player 232 (FIG. 2) responsively to timing data from the captioning index which locates the scene corresponding to the previous user queries 312 and 316.

Returning now to FIG. 2, upon receipt of user inputs responsive to the navigation menu (300 in FIG. 3) from user input device 265 through user communication interface 205 on line 204, processor 202 sends synchronization data from the captioning index that is responsive to the user search query. In this illustrative example, the synchronization data takes the form of timing data that identifies the point in time in the video stream that contains the captioning matching the user query.

Processor 202 passes the timing data to video player communication interface 247 over line 203. Video player communication interface 247 provides the signal from processor 202 as video player operating commands 252 which are sent to video player 235. The video player operating commands 252, which include the timing data from the captioning index, are received by video player 232 on line 255.

The communication link between the video player communication interface 247 and video player is selected from a variety of conventional formats including a) wireless RF (radio frequency) communication protocols such as the Institute of Electrical and Electronics Engineers IEEE 802 family of wireless communication standards, Bluetooth, HomeRF, ZigBee, etc; b) infrared (“IR”) communication formats using devices such as IR remote controls, IR keyboards, IR “blasters” or other IR devices conforming to Infrared Data Association (“IrDa”) specifications; and, c) hardwire connections using, for example, the RS-232 serial communication protocol, parallel, USB (Universal Serial Bus), IEEE 1394 (“FireWire”) connections, and the like. With the RS-232 protocol, a RS-232 command set may be utilized to command the video player 235 to jump to specific scenes in a video which correspond to the captions of interest.

Responsively to the timing data in the operating commands 252, video player 232 advances (or goes back, as appropriate) to play the scene containing the dialogue matching the user query. In the example using the Star Wars dialogue, the timing data is 60:49. The video player goes to a point in the movie 60 minutes and 49 seconds from the start to play the scene with the line “Hokey religions and ancient weapons are no match for a good blaster at your side, kid.” © 1977, 1997 & 2000 Lucasfilm Ltd.

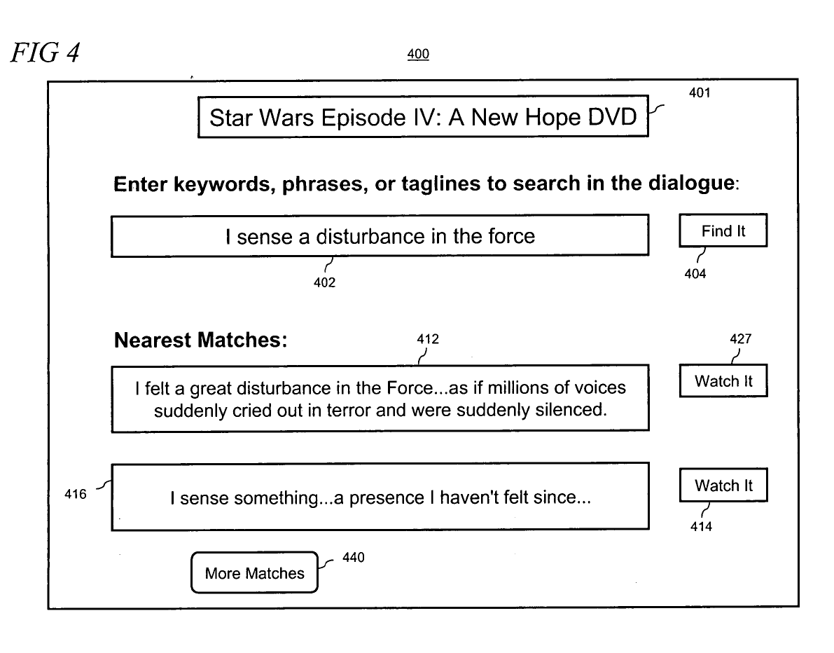

FIG. 4 is an illustrative example of a graphical navigation menu 400 using closed captioning in which nearest matches to user queries are displayed. As with FIG. 3, the movie video source in this example is a DVD, as indicated by the title field 401. A user input field 402 is arranged to accept alphanumeric input from the user which forms the user query. Button 404 labeled “Find it” is arranged to initiate the search of the captioning index once the query is entered in input field 402.

As shown, the user input is the phrase “I sense a disturbance in the force.” Although this exact phrase is not contained in the movie dialogue (and hence is not included in the captioning index), several alternatives which most nearly match the user query are located in the captioning index and displayed on the graphical navigation menu 400. These nearly-matching alternatives are shown in fields 412 and 416. Optionally, graphical navigation menu 400 is arranged to show one or more thumbnails (i.e., a reduced-size still shot or motion-video) of video that correspond to the fields 412 and 416. Such optional thumbnails are not shown in FIG. 4.

A variety of conventional text-based string search algorithms may be used to implement the search of the captioning contained in a video depending on the specific requirements of an application of video navigation using closed captioning. For example, fast results are obtained when the captioning text is preprocessed to create an index (e.g., a tree or an array) with which a binary search algorithm can quickly locate matching patterns.

Known correlation techniques are optionally utilized to locate captions that most nearly match a user query when an exact match is unavailable. Accordingly, a caption is more highly correlated to the user query (and thus more closely matching) as the frequency with which search terms occur in the caption increases. Typically, common words such as “a”, “the”, “for” and the like, punctuation and capitalization are not counted when determining the closeness of a match.

As shown in FIG. 4, the caption in field 412 has three words (not counting common words) that match words in the search string in field 416. The caption in field 416 has two words that match. Accordingly, the caption contained in field 412 in FIG. 4 is a better match to the search string contained in field 402 than the caption contained in field 416. Close matching captions, in this illustrative example, are rank ordered in the graphical navigation menu 400 so that captions that are more highly correlated to the search string are displayed first.

In some instances, more matches might be located than may be conveniently displayed on a single graphical navigation menu screen. This may occur, for example, when the search string contains a relatively small number of keywords or a particularly thematic word (such as the word “force” in this illustrative example) is selected. Button 440 on graphical navigation menu may be pressed by the user to display more matches to the search string when they are available.

Other common text-based search techniques may be implemented as needed by a specific application of closed-captioning-based video navigation. For example, various alternative search features may be implemented including: a) compensation for misspelled words in the search string; b) searching for singular and plural variations of words in the search string; c) “sound-alike” searching where spelling variations—particularly for names—are taken into account; and, d) “fuzzy” searching where searches are conducted for variations in words or phrases in the search string. For example, using fuzzy searching, the search query “coming fast” will return two captions: “They're coming in too fast” and, “Hurry Luke, they're coming much faster this time” where each caption corresponds to a different scene in the movie to which a user may navigate. © 1977, 1997 & 2000 Lucasfilm Ltd.

FIG. 5 is an illustrative example of an optionally utilized graphical navigation menu 500 in which pre-selected dialogue is displayed. In this example, the user may jump to a number of different scenes using dialogue as a navigation aide. The movie video source is a DVD as indicated by the title field 501. In this illustrative example, five different scenes containing the dialogue shown in fields, 512, 516, 518, 521 and 523 are available to the user. Additional scenes/dialogue are available for user selection by pressing button 550. The user may also go to the search screens shown in FIGS. 3 and 4 by pressing button 555.

In the illustrative example shown in FIG. 5, a captioning index is generated in accordance with the method shown in FIG. 1 and described in the accompanying text. Dialogue and corresponding scenes in the video program are selected in advance, for example, by the video content author such as a movie production studio, or more typically by a video content service provider such a cable television provider. The pre-selected dialogue and scenes are presented to the user who may jump to a desire scene by pressing a corresponding buttons 527, 529, 533, 535 and 538, respectively, on graphical video navigation menu 500. Optionally, one or more thumbnails of scenes containing the pre-selected dialogue are displayed in graphical navigation menu 500 to aid a user in navigating to desired content. Such optional thumbnails are not shown in FIG. 5.

The present arrangement advantageously enables additional value-added video navigation services to be conveniently provided to video content service subscribers for all existing video content that is encoded with closed captioning. For example, in VOD or DVR applications, the service provider may provide graphical navigation menus like those shown in FIGS. 3, 4 or 5. A user may access a graphical navigation menu using the same remote control that is used to select and receive a VOD program or operate the DVR (in many applications, a single remote control is used to operate STB and DVR and select VOD programs). By using the remote control, the user brings up the graphical navigation menu whenever desired to navigate backwards or forwards in the video program. As described above, the user chooses from pre-selected dialogue and scenes to jump to, or enters a search string to navigate to a desired scene which contains the dialogue of interest.

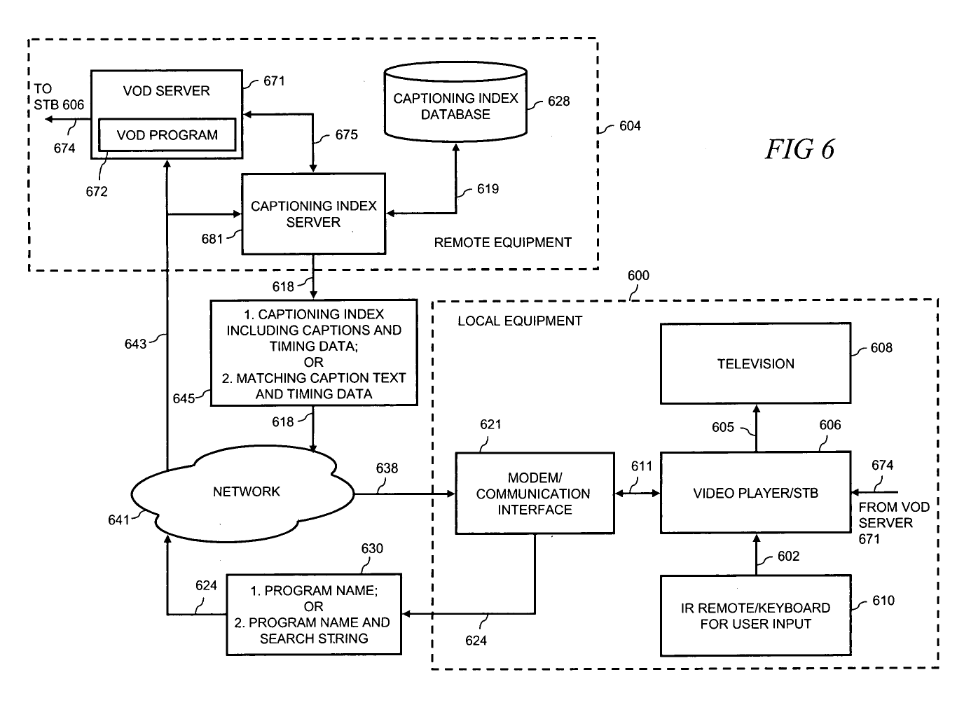

FIG. 6 is a block diagram of illustrative arrangement showing video navigation using closed captioning with local and remotely-located equipment. Such an arrangement may be advantageously implemented in client-server-type network topologies where a plurality of captioning indexes are generated and served from a central location.

Local equipment 600 includes a video player 606 (which may be selected from devices including DVD players, DVRs, VCRs, or STBs) which is coupled to television 608 on line 605 as shown. A user input device 610 comprising, for example, either a remote control (such as an IR remote control), a keyboard, or a combination of remote control and keyboard is operatively coupled to video player 606 on line 602.

Modem 621 or other communications interface (for example, a broadband or local area network connection) is operatively coupled to video player 606 on line 611. Modem 621 is arranged to implement a bidirectional communication link between local equipment 600 and remote equipment 604 over network 641. In alternative configurations, communication between the local equipment 600 and remote equipment 604 uses more than one communications path. For example, upstream and downstream communications may use multiple paths. Downstream connections may also be arranged so that data streams are separate from program streams and received using an out-of-band receiver. Modem 621 is accordingly arranged to meet the requirements of the specific communication configuration utilized.

As indicated by reference numeral 630 in FIG. 6, a user query generated at user input device 610 in local equipment 600 includes either i) a video program name and search string (e.g., a keyword, phrase or tagline that a user anticipates is contained in a video program of interest). This user query is typically used in settings where remotely-hosted captioning searches are utilized; or, ii) a video program name. This user query is typically used in a setting where locally-hosted captioning searches are utilized. The query 630 is carried over network 641 on lines 624 and 643 to captioning index server 681 in remote equipment 604.

Captioning index server 681 is coupled through line 619 to captioning index database 628 which contains one or more captioning indexes generated in accordance with the illustrative method shown in FIG. 1 and described in the accompanying text. Responsively to the user query 630, the captioning index server 681 will search the captioning index database 628. If the user query contains just the video program name to facilitate locally-hosted captioning searching, the captioning index server will send the captioning index comprising the captions and the synchronization data (e.g., timing data) back to the video player 606 over network 641. If the user query includes a program name and a search string to facilitate remotely-hosted captioning searching, then the captioning server 681 will send responsive synchronization data (e.g., timing data) back to video player 606.

The data sent from the captioning server 681 is indicated by reference numeral 645 in FIG. 6. Captioning server data 645 typically includes either: 1) the captioning index including captions and associated synchronization data (e.g., timing data); or 2) caption text from the program that matches, or most nearly matches, the user search string and associated synchronization data (e.g., timing data). Matching, or most nearly, caption text is optionally utilized as shown in FIG. 4 and described in the accompanying text.

Captioning server data 645 is sent via line 618 from the captioning server 681 to network 641 which in turn relays the captioning server data to modem 621 over line 638. Modem 621 provides the captioning server data 645 to video player 606.

In the locally-hosted captioning search setting where the user sends only a program name in the query, video player 606 is configured to implement the method shown by blocks 122 through 140 in FIG. 1 and described in the accompanying text. The entire captioning index is downloaded from the captioning server 681 to video player 606 which thereby enables a user to locally search the captioning index using user interface 610. Alternatively, a STB or a standalone electronic device is arranged to implement the method shown in blocks 122 through 131 in FIG. 1.

Local captioning searching may be performed with locally-provided video content such as that stored on DVD. In an illustrative example, a STB downloads and stores the captioning index associated with the program on the DVD. The STB sends timing data (as in block 131 of FIG. 1) responsively to user caption search requests to video player 606 over a communication link which is selected from an IR link, wireless RF link or hardwire connection such as an RS-232 cable.

Local captioning searching is further described using an illustrative VOD example of network-provided video content. To select a program from a VOD service, a user typically interacts with an electronic program guide that is displayed on a television through the STB. A VOD server 671 (located remotely at cable network head end, for example, in remote equipment 604) retrieves the selected VOD program 672 and streams the VOD program 672 to the STB 606 on line 674 via network 641. Prior to starting play of the selected VOD program 672, the captioning index is downloaded from the captioning index server 681, in this illustrative example, to the user's STB 606 which is configured to store the captioning index and search the captioning index responsively to user caption search requests. As the video content is provided from the remote cable network head end, timing data resulting from the caption searching is sent from local equipment 600 over network 641 to set the VOD program 672 provided by the VOD server 671 to the appropriate scene responsively to the user's caption search requests.

In the remotely-hosted caption search setting, a user sends both the program name and the search string in the query to the captioning index server 681 at the remote equipment 604 which is commonly configured in a cable network head-end. Responsive timing data from the captioning server is downloaded to the video player 606 over network 641.

In cases where locally-provided video content is used (e.g., DVD, videocassette), the video player 606 operates to advance (or go back) to a location in the video program in response to timing data according to the method shown in blocks 131 and 140 of FIG. 1 and described in the accompanying text.

In cases where network-provided video content is utilized (for example, in a VOD application), the captioning index server sends timing data to the VOD server 671 over line 675 to set the VOD program 672 to the appropriate scene matching the user's caption search requests which is then streamed on line 674 via network 641 to STB 606. Caption text from the program matching (or most nearly matching) the user's search request is provided from the captioning index server 681 over network 641 to local equipment 600 for optional display on user interface 262 (FIG. 2).

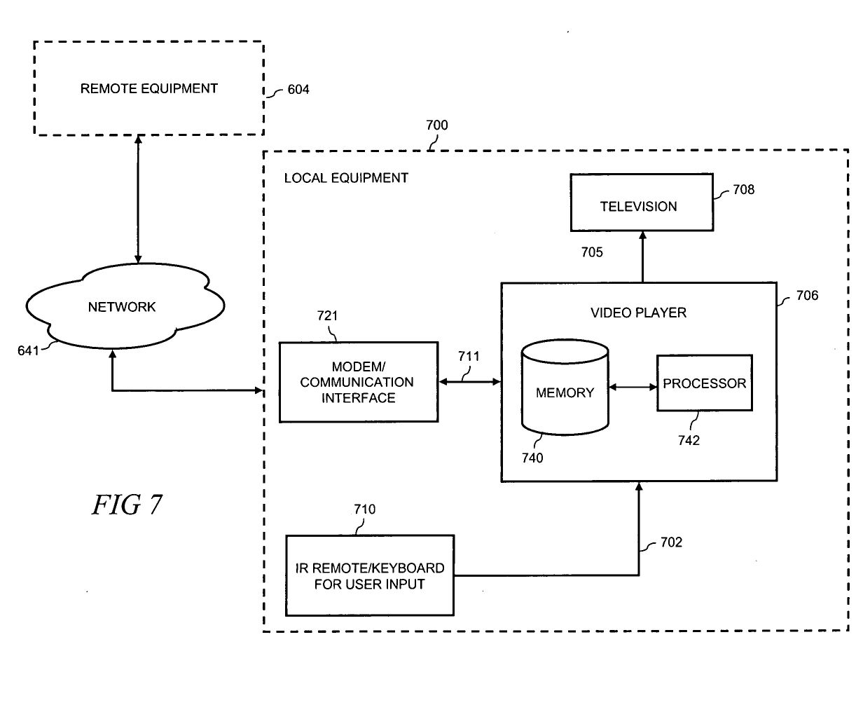

FIG. 7 is a block diagram showing details of the local equipment for video navigation using closed captioning. Remote equipment 604 is coupled to local equipment 700 over network 641. Video player 706 is optionally arranged to include a processor 742 that is coupled to a memory 740. Processor 742, in this illustrative example, is arranged to perform similar captioning index searching and input/output functions as processor 202 in FIG. 2. Memory 740 is arranged to store a captioning index in instances where the captioning index is downloaded from the remote equipment 604. Processor 742 and memory 740 function to enable captioning index searching while the video continues to run in the background which may be desirable in some applications. In some implementations of local equipment 700, it may be desirable to integrate the processor and memory functions described above into existing processors and memories that are used to implement other functions in the video player 706.

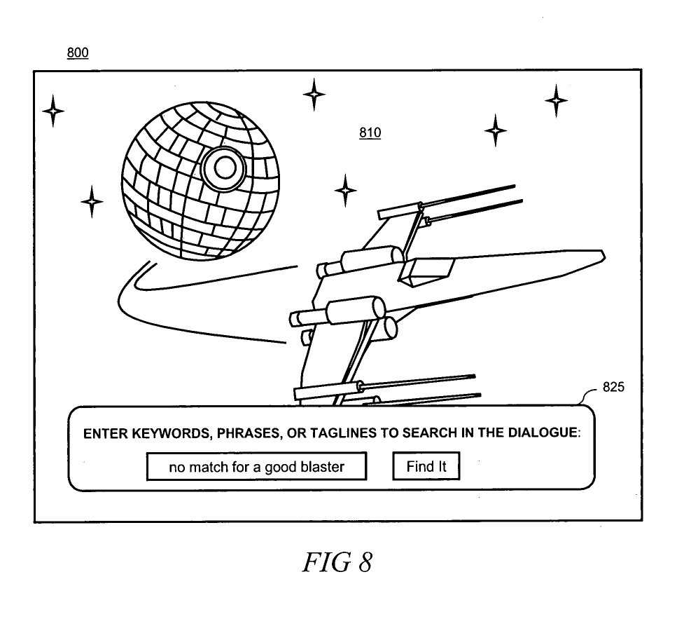

FIG. 8 is a pictorial representation of a television screen shot 800 showing a video image 810 and a graphical navigation menu 825 that is superimposed over the video image 810. In this illustrative example, the video 810 runs in normal time in the background. Video player 706 (FIG. 7), as described above, displays the graphical navigation menu 825 as a separate “window” that enables a user to simultaneously watch the video and search captioning contained therein.

Each of the various processes shown in the figures and described in the accompanying text may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A video navigation method, comprising:
receiving a video stream encoded with captioning;
decoding the captioning; and
generating a user-searchable captioning index comprising the captioning, and synchronization data indicative of synchronization between the video stream and the captioning.

2. The method of claim 1 further including providing an interface to a user for searching the captioning index.

3. The method of claim 1 where the synchronization between the video stream and the captioning is time-based.

4. The method of claim 1 where the synchronization between the video stream and the captioning is video frame-based.

5. The method of claim 1 where the synchronization between the video stream and the captioning is marker-based utilizing metadata that points to a location in the video stream.

6. The method of claim 2 further including identifying a portion of the captioning index that is responsive to the searching.

7. The method of claim 6 further including sending synchronization data associated with the identified portion of the captioning index.

8. The method of claim 2 where the searching comprises comparing a search term against the captioning index.

9. The method of claim 1 where at least one of the receiving, decoding and generating is performed on a server disposed at a cable network head end.

10. The method of claim 1 where at least one of the receiving, decoding and generating is performed on a server that is accessible over the Internet.

11. Video navigation apparatus, comprising:
a video receiving interface for receiving a video stream encoded with captioning;
a processor for generating a captioning index comprising the captioning and synchronization data indicative of synchronization between the video stream and the captioning; and
a communications interface for receiving user requests for searching the captioning index.

12. The video navigation apparatus of claim 11 where the processor further identifies a portion of the captioning index that is responsive to the user requests.

13. The video navigation apparatus of claim 11 where the processor further transmits synchronization data associated with the identified portion of the captioning index.

14. The video navigation apparatus of claim 13 further comprising a video player which plays a scene in video program responsively to the synchronization data, the scene containing captioning in the identified portion of the captioning index.

15. The video navigation apparatus of claim 14 where the video player is a DVD player or a DVR.

16. The video navigation apparatus of claim 11 further including a display information interface for sending display information that is presentable as an interactive navigation menu on a user interface.

17. The video navigation apparatus of claim 16 where the user interface further includes a remote control device for providing user inputs responsive to the interactive navigation menu.

18. The video navigation apparatus of claim 17 where the remote control device is arranged to receive voice input.

19. The video navigation apparatus of claim 16 where the user interface further includes an alphanumeric character input device for providing alphanumeric user input to the interactive navigation menu.

20. The video navigation apparatus of claim 19 where the alphanumeric user input comprises a phrase or a keyword.

21. The video navigation apparatus of claim 20 where the interactive navigation menu displays captioning from the captioning index that matches, or most nearly matches, the phrase or keyword.

22. The video navigation apparatus of claim 11 further including a video player interface selected from one of USB, USB 0.9, USB 1.0, USB 1.1, USB 2.0, serial, parallel, RS-232 and IEEE-1394.

23. The video navigation apparatus of claim 16 in which a thumbnail of a scene is displayed with the interactive navigation menu.

24. At least one computer-readable medium encoded with instructions which, when executed by a processor, performs a method comprising:
receiving a video stream encoded with captioning;
generating a captioning index comprising the captioning and synchronization data indicative of synchronization between the video stream and the captioning; and
providing an interface to a user for searching the captioning index.

25. The at least one computer-readable medium of claim 24 where the captioning comprises closed captioning.

26. The at least one computer-readable medium of claim 24 where, responsive to the synchronization data, a video player plays a portion of a video program.

27. The at least one computer-readable medium of claim 24 further including providing an interface to a user to select from one or more scenes in the video stream using dialogue from the one or more scenes as the selection criteria.

28. The at least one computer-readable medium of claim 27 where the dialogue comprises relatively well known or famous tag lines or phrases from shows, commercials or movies.
